(19) United States
(12) Patent Application Publication
(10) Pub. No.: US 2022/0166812 A1
(43) Pub. Date: May 26, 2022

(54) HOW TO CONTROL THE INVOLVEMENT OF ONLINE CONFERENCE PARTICIPANTS

(71) Applicant: Faisal Ashfaq Satti Mohammad, Islamabad (PK)

(72) Inventor: Faisal Ashfaq Satti Mohammad, Islamabad (PK)

(21) Appl. No.: 17/602,299

(22) PCT Filed: Apr. 16, 2019
(86) PCT No.: PCT/RU2019/000252

§ 371 Date: Oct. 8, 2021

(51) Int. Cl. H04L 65/4038

(52) U.S. Cl. CPC H04L 65/4038

(57) ABSTRACT

Method and systems for conference communication that can be used to control involvement of participants in an online conference (OC) are provided. In the method, when an OC is conducted, a chairperson (presenter), or a representative thereof, monitors engagement of participants in the OC, observing an OC participant directly via a webcam of participant. At any time during conducting the OC, the chairperson, or a representative thereof, can also inspect screens of computers or other devices used by participants to take part in OC; and can turn on a pop-up window function on the screen of a computer or other device of an OC participant. The pop-up windows appear at random on the screen and the participant must promptly click on them. The method makes it possible, when conducting an OC, to collect largest possible amount of information with regard to engagement and state of a participant in said conference.

### CROSS-REFERENCE TO RELATED APPLICATIONS

This application is a national stage application of the Patent Cooperation Treaty (PCT) international application titled “METHOD FOR MONITORING THE ENGAGEMENT OF PARTICIPANTS IN AN ONLINE CONFERENCE”, international application number PCT/RU2019/000252, filed in the Russian Patent Office on Apr. 16, 2019. The specification of the above referenced Patent application is incorporated herein by reference in its entirety.

### FIELD OF THE INVENTION

The invention relates to the field of image transmission, namely to the field of systems for conference communication and can be used to control the involvement of participants in an online conference.

### BACKGROUND

A technical solution is known for the international patent for the invention U.S. Pat. No. 5,473,367 (priority date May 12, 1995) “Video View Selection by a Chairperson”. This technical solution is characterized by the fact that it allows one of the conference participants to assume the role of manually manipulating the contents of the video image, which will be visible to all participants (the so-called view of the chair). In addition, each participant is allowed to independently determine the content of the video image or choose the type of chair. These features provide the reality of a virtual meeting room and allow other conference participants to free themselves from manipulating their own video image content. In addition, any of the conference participants can take on the role of determining the view of the chair, which allows you to control the shift of the angle of the view of the chair when changing the main speaker in a video conference. The following essential features of this technical solution coincide with the claimed technical solution “Method for controlling the involvement of participants in an online conference”: this method allows the chairman of the conference to manipulate the content of a video image broadcast to other participants of the conference.

The closest technical solution (prototype) is the technical solution for the international patent for the invention No CN1072774 (priority date Oct. 20, 2017) “Method for assessing the condition of the participant on the spot in real time”. This technical solution is characterized by the fact that it provides a way to evaluate the effectiveness of the conference in real time by collecting a video or image of a conference participant, processing and analyzing the video or image and dynamically evaluating the conference in accordance with the corresponding video or image content standard. The participants of the meeting see the effectiveness of the meeting; evaluate the attention of the participants on the spot, the general and poor ratio in real time and specific allocation of seats, statistics of information about the status of participants in real time, and also understand the main factors affecting the effectiveness of the meeting in real time, including sitting posture, bad phenomena, staff location, number of staff, etc. They provide the organizer or speaker with information about the status of participants in real time, which significantly improves the quality and efficiency of the meeting. The following essential features of this technical solution coincide with the claimed technical solution “Method for monitoring the involvement of participants in an online conference”: this method provides for viewing in real time the status of the conference participants themselves to assess the participant's involvement and increase the overall effectiveness of the conference.

The technical solutions listed above have a number of disadvantages:
the technical solution for the patent for the invention No CN 1072774 is limited to viewing the status of participants only offline conferences;
Technical solutions for patents for inventions No's, U.S. Pat. No. 5,473,367, CN1072774 only allow you to observe the participants of the conference, but does not allow you to take any measures to increase the involvement of participants in the work of the conference; and
the technical solution for the patent for the invention U.S. Pat. No. 5,473,367 is limited to manipulating the general video image available to all participants of the conference, which does not allow to increase the effectiveness of the involvement of specific participants of the conference.

### SUMMARY OF THE INVENTION

A way to control the involvement of participants in an online conference.

The invention relates to the field of image transmission, namely to the field of systems for conference communication and can be used to control the involvement of participants in an online conference.

The claimed method of monitoring the involvement of participants in an online conference allows us to solve the technical problem of the lack of control over the status and involvement of participants in an online conference, when the organizers themselves do not have the opportunity to personally approach and address a particular participant of the conference and take other measures possible during an offline conference.

The technical result is achieved by the fact that the claimed method of monitoring the involvement of participants in an online conference is characterized by the fact that during an online conference, the chairman (speaker) or his representative controls the involvement of participants in an online conference by monitoring the participant of the online conference directly through the conference participant's webcam, characterized in that at any time during the online conference, the chairman (speaker) or his representative can also view computer screens and other devices, with the help of which participants participate in the online conference, the chairman (speaker) or his representative can enable the pop-up function on the computer screen or other device of the participant of the online conference, and pop-up windows appear randomly on the computer screen or other device of the participant of the online conference in different places on the screen, and the participant must click on these pop-up windows in a timely manner.

### DETAILED DESCRIPTION OF THE INVENTION

In contrast to the prior art, the inventive method for monitoring the involvement of online conference participants provides the possibility of viewing the screens of computers and other devices of online conference participants and is used only when carrying out online conference, and also makes it possible to use the function of pop-up windows during online conference to monitor the state of the online conference participant.

The claimed method of monitoring the involvement of participants in an online conference allows us to solve the technical problem of the lack of control over the status and involvement of participants in an online conference, when the organizers themselves do not have the opportunity to personally approach and address a particular participant of the conference and take other measures possible during an offline conference.

Accordingly, the technical result of the claimed technical solution “Method for monitoring the involvement of participants in an online conference” is that it allows to collect the largest possible amount of information about the involvement and condition of a participant in this conference during an online conference, which increases the effectiveness of subsequent analysis of the participant's condition, as well as take measures to check the condition of an online conference participant, which will increase the participant's concentration and involvement in the conference. The claimed technical solution will be most useful when holding online conferences that require maximum concentration of participants and their active work, in particular, online conferences of an educational nature, business conferences, etc.

The technical result is achieved by the fact that the claimed method of monitoring the involvement of participants in an online conference is characterized by the fact that during an online conference, the chairman (speaker) or his representative controls the involvement of participants in an online conference by monitoring the participant of the online conference directly through the conference participant's webcam, characterized in that at any time during the online conference, the chairman (speaker) or his representative can also view computer screens and other devices, with the help of which participants participate in the online conference, the chairman (speaker) or his representative can enable the pop-up function on the computer screen or other device of the participant of the online conference, and pop-up windows appear randomly on the computer screen or other device of the participant of the online conference in different places on the screen, and the participant must click on these pop-up windows in a timely manner.

To obtain a technical result, the invention can be carried out as follows. The Chairman (speaker) of the online conference or his representative conducts an online conference among other participants. The chairman (speaker) of the online conference or his representative should know to what extent the conference participants are involved in the work, which participants take part in the conference and which do not take part, for example, are distracted, view other information on the computer screen or other device, whether the attention of the conference participants is concentrated at one time or another. For these purposes, the chairman (speaker) of the online conference or his representative has the opportunity to monitor the participant of the online conference directly through the participant's webcam, view the screens of computers and other devices with which participants participate in the online conference, enable the function of pop-up windows on the computer screen or other device of the participant of the online conference, and pop-up windows appear randomly on the computer screen or other device of the participant of the online conference in different places of the screen, and the participant must click on these pop-up windows in a timely manner. The chairman (speaker) of the online conference or his representative thus receives the maximum possible amount of information about the involvement of the conference participant in the work in the form of a direct video image of the participant and the surrounding space during the conference, information about whether the participant is distracted by other information on his computer screen or other device other than related to the work, and can also check and increase the concentration of the participant's attention.

The presented invention expands the arsenal of tools for monitoring the involvement of participants in an online conference and is distinguished by the fact that it allows you to collect the largest possible amount of information about the involvement and condition of a participant in this conference during an online conference, as well as take measures to check the condition of a participant in an online conference and increase his concentration of attention.

I claim:

1. A method of monitoring the involvement of participants in an online conference, characterized by the fact that during an online conference, the chairman (speaker) or his representative monitors the involvement and status of participants in an online conference by monitoring the participant of the online conference directly via the conference participant's webcam, characterized in that at any time during the online conference, the chairman (speaker) or his representative can also view computer screens and other devices, with the help of which participants participate in the online conference, the chairman (speaker) or his representative can enable the pop-up function on the computer screen or other device of the participant of the online conference, and pop-up windows appear randomly on the computer screen or other device of the participant of the online conference in different places on the screen, and the participant must click on these pop-up windows in a timely manner.

2. A method for monitoring the involvement of participants in an online conference according to claim 1, characterized in that information based on the results of checking the concentration of attention of a conference participant using the pop-up window function is saved, analyzed and becomes available to the chairman (speaker) or his representative.

3. A method for monitoring the involvement of participants of the online conference according to claim 1, characterized in that the right of the chairman (speaker) of the online conference or his representative to view the screens of computers and other devices with which participants participate in the online conference can be communicated to the participants of the online conference orally or in the user agreement.
